(19) United States
(12) Patent Application Publication
(10) Pub. No.: US 2009/0148335 A1
(43) Pub. Date: Jun. 11, 2009

(54) PROCESS FOR SURFACE TREATMENT OF METALS

(76) Inventors: Richard E. Adair, Urbandale, IA (US); Andreas Lindert, Troy, MI (US)

Correspondence Address: HUSCH BLACKWELL SANDERS LLP, 4801 Main Street, Suite 1000, KANSAS CITY, MO, 64112, US

(21) Appl. No.: 12/335,072

(22) Filed: Dec. 15, 2008

Related U.S. Application Data
(63) Continuation-in-part of application No. 11/679,997, filed on Feb. 28, 2007.

(51) Int. Cl. C22C 38/00; C23G 1/02; C09K 13/04

(52) U.S. Cl. 420/8; 134/3; 216/108; 252/79.2

(57) ABSTRACT

A process for treating metal to remove oxidation or contaminants or prepare the metal for processing without unduly damaging the metal. A formulation of sulfuric acid, water, and either ammonia or a sulfate salt of ammonia (or both) is used to treat the metal. The sulfuric acid is effective in removing impurities and contaminants, while the ammonia or ammonia salt reduces the otherwise damaging effect sulfuric acid has on metal.

### CROSS-REFERENCE TO RELATED APPLICATIONS

This application is a continuation-in-part of and claims priority to U.S. application Ser. No. 11/679,997; filed Feb. 28, 2007 and entitled “Process for Surface Treatment of Metals”, which document is hereby incorporated by reference herein to the extent permitted by law.

### FIELD OF THE INVENTION

The present invention relates generally to a process for the use of a modified sulfuric acid for the purpose of cleaning, deoxidizing, descaling, polishing, and/or brightening metals (including stainless steel), and/or preparation of the metal for coating or plating, or to render the surface of the metal in a desired final state such as in an anodizing process.

### BACKGROUND OF THE INVENTION

Sulfuric acid is one of the most widely purchased commodities in the world and is widely used in a variety of industries. A primary area of use for sulfuric acid is within the fields of metal working and remedial metal treatment. Generally, the metal working field includes the processing chain from rolling metals into sheets after smelting to the final steps of coating finished metal components with paints or other coatings or polishing of the metal surface itself. The metal working field also includes foundry and metal casting processes and the steps to achieve their end products.

At many of the process steps within the metal working field, impurities such as oxidation, organic and inorganic contaminants and soils, and certain scales (laser cut scale, plasma cut scale, and/or weld splatter or weld scale) may need to be removed from metal surfaces prior to further processing of the metal into a finished part. Additionally, metal working involves processes such as anodizing where an acid is used for the purpose of imparting the desired metal finish or metal surface characteristics.

Remedial metal treatment generally entails repair type treatments of metal surfaces such as cleaning, oxidation removal, anodizing, polishing, or brightening. In both metal working and metal treatment, the desired result can either be to clean the metal as an end product or to prepare the metal to adequately accept intermediate coatings such as phosphate or zinc based conversion coatings and/or paint primers, or a final coating such as paint or a powder coating.

While sulfuric acid is a relatively economical acid to use compared to other available acids, and it can quickly and efficiently remove oxidation, scales, and other organic and inorganic contaminants from metals, the use of sulfuric acid in these applications has been somewhat limited due primarily to two factors.

First, the aggressiveness of sulfuric acid is so profound that while it is highly effective to remove unwanted surface items or contaminants, it also often attacks the base metal and can damage the surface of the metal and thus make the metal unusable or undesirable. By reason of its aggressiveness, sulfuric acid can be highly damaging to production process equipment used in the metal working and remedial metal treatment industries. Second, the aggressiveness of the sulfuric acid on organics (such as human skin) makes it an extremely dangerous compound with which to work from a personal safety standpoint.

Because of the aforementioned drawbacks of sulfuric acid, alternative products and methods have generally been used for metal working and metal treatment. Typically, the alternatives have either been less aggressive acids (such as phosphoric acid) or mechanical methods.

Mechanical removal of unwanted surface items has typically involved grinding, medium (sand) blasting, or sanding. Mechanical removal is labor intensive, expensive and inexact. In cases where close tolerances are required on a finished part, mechanical removal often results in finished parts which are out of tolerance and unusable without expensive rework of the part. Frequently, even reworking the parts cannot make them useful in a close tolerance application.

Chemical removal has typically required acid based compounds which are less aggressive and which avoid the personal safety issues associated with sulfuric acid. Unfortunately, use of relatively mild acids requires increased production times, elevation of the acid solution temperatures, or increased acid concentrations either singularly or in some combination with increased temperature and/or processing time. All of these requirements significantly increase the costs of the metal working or metal treatment operation.

A typical example of chemical removal of unwanted contaminants or scales is the use of weak acids or organic acids such as phosphoric or citric acids. Phosphoric acid is relatively mild, and the problems of increased concentration, time and energy spent to elevate processing temperatures are encountered.

With citric acid, the same drawbacks are present as with phosphoric acid, along with the additional drawback that citric acid has a tendency to chelate metals. The chelation of metals in the waste streams of metal working facilities requires removal of the chelated metal ions from waste water; an extremely difficult and expensive process. Effluents containing metal ions can not be released into private or municipal waste treatment systems because such effluent might be discharged into streams and waterways and cause unacceptable contamination and pollution.

In some cases, inorganic acids such as nitric acid have been used to chemically remove oxidation, soils, or scales from metal. However, the risk of generating and releasing poisonous nitrous oxide gas makes nitric acid unacceptable for widespread use. Another inorganic acid, hydrochloric acid, has proven unsuitable for use in metal working because of its corrosiveness to base metals and/or its general inability to remove target contaminants.

In the metal working industry, sheets, rods, bars, or blocks of metal (both ferrous and non-ferrous) are produced in a mill, whereas castings are produced in a foundry. In the case of ferrous metals such as steel which are often shipped as hot rolled or cold rolled products, surface impurities are often present. The same is true for castings. These impurities are typically surface oxidation or mill scales. Such impurities must be removed prior to shipping to the end customer, or by the customer in the field prior to applying intermediate coatings (conversion coatings and/or primers) or final finishes such as paint, if a well adhered coating or finish is to be achieved.

With technological advances, new challenges of treating or preparing the surfaces of metal have been encountered. Whereas metal sheets were once cut into desired patterns or shapes through “shearing” (mechanically cutting), they are now often cut by plasma or laser techniques. Shearing leaves the surface of the metal reasonably clean; however, plasma or laser cutting leaves scale on the edges where the metal is cut. This scale must be removed prior to applying a coating or finish to the metal because the scale will not adequately accept an intermediate conversion coating step, such as iron or zinc phosphatizing and/or priming, nor will scale adequately accept a final coating such as paint. Without an intermediate or final finish of adequate adhesion and high integrity on the metal, the coating or finish is susceptible to failure. The result (at least for ferrous metals not including stainless steel) is that oxidation can develop at the failed point and migrate under the intermediate and/or final finish and create progressively larger areas of failure. In the case of non-ferrous metals, oxidation of the base metal may or may not develop, but the finish is highly likely to fail because the surface impurities create pathways for moisture migration under the finish.

The field of remedial metal treatment includes deoxidation or cleaning of metals and/or the removal of weld scales or laser or plasma cut scales, as well as processes of anodizing or plating. Additionally, remedial metal treatment includes the cleaning and polishing of metals such as brass, silver, or chrome used in a wide variety of applications.

### SUMMARY OF THE INVENTION

In accordance with the present invention, a modified sulfuric acid is used to clean, deoxidize, descale, polish, and/or brighten metals. The modified sulfuric acid may also be used to prepare the metal for coating or plating, or in a process, such as anodizing, where a desired final surface condition is achieved. Further, this invention may involve the use of various compounds with the modified sulfuric acid to act as accelerators, inhibitors, and/or buffers and/or surfactants, to mitigate, control, or eliminate acid attack (etch) on metals and/or enhance the removal of soils, scales, metal tarnish, or oxidation present on the metal surface, or the improvement of a final finish on the metal such as with anodizing processes.

The modified sulfuric acid is formulated by combining sulfuric acid with water and either ammonia and/or a sulfate salt of ammonia. A preferred formulation includes about 4.8 pounds of water mixed with about 6.3 pounds of sulfuric acid, with about 0.3 pounds of anhydrous ammonia thereafter being added, although the proportions can vary.

### DESCRIPTION OF THE PREFERRED EMBODIMENT

This invention is directed to a metal treatment process making use of a compound which includes sulfuric acid, water, and ammonia or ammonium sulfate compounds. Specifically, the preferred constituents are 66 degree Baume commercial sulfuric acid, water, and anhydrous ammonia, wherein the sulfuric acid and water are preferably first blended together and then the anhydrous ammonia is directly injected into this mixture.

While the proportions can vary, it has been found that an effective formulation is obtained by first mixing about 4.8 pounds of water with about 6.3 pounds of sulfuric acid (H₂SO₄, 66 Be or 93%), and then adding 0.3 pounds of anhydrous ammonia (NH₃). Chemically, the following reaction takes place: H₂SO₄+NH₃→(NH₄)HSO₄ (aqueous). The final solution that results has the same amount of water (4.8 pounds), about 4 pounds of sulfuric acid and about 2 pounds of ammonium bisulfate. This amounts to about a 36% solution of sulfuric acid and about an 18% solution of ammonium bisulfate.

The anhydrous ammonia can be replaced by a sulfate salt of ammonia (ammonium sulfate or ammonium bisulfate), or a combination of ammonia and a sulfate salt of ammonia. In any case, the ammonia or sulfate salt of ammonia has been found effective in reducing the extent to which sulfuric acid attacks metals that are undergoing treatment, while at the same time not detracting from the effectiveness of the sulfuric acid in removing oxidation and other impurities.

Multiple tests to determine the effects of the modified sulfuric acid for cleaning scale removal and metal loss characteristics have been conducted on commercially available metal parts. Commercially available metal test panels were also used to validate performance and/or eliminate/minimize observation variances that could occur because of production variables present in the tested metal parts.

Controls and comparison standards for the tests were provided using commercially available prior art products: first, a product commercialized by Henkel Corp.; second, hydrochloric acid; and third, an ammoniated acid. All products were tested for like amounts of time at like temperatures and on like parts. Solution strengths of tested acids were identical with two exceptions. In the case of the commercially available products from Henkel, solution strengths were also run at their commercially recommended usage strength levels. In the case of the modified sulfuric acid of the present invention and the ammoniated acid, solution strength levels were reduced until the products failed to perform. All products were tested with and without the addition of metal attack inhibiting compounds. (Rodine 85 and Rodine 31A available from Henkel Corporation.)

The ability to remove both laser and weld scale from production parts was tested on commercially available metal parts and commercially available test panels. The additional factor tested was metal etch or removal, measured as milligrams of loss per square foot as is standard for this type of test.

To investigate the possible reduction of metal loss in the scale removal tests, a second set of tests was conducted which involved the use of the inhibitors Rodine 85 and Rodine 31A incorporated into the solutions of the acids tested. These inhibitors are intended to reduce metal loss in deoxidizing and descaling processes.

Several acid cleaners were evaluated using laser-cut, welded metal pieces made for this study. The acid cleaners evaluated were Acid Deoxidizer #1, Acid Deoxidizer #2 (both commercially available), an ammoniated sulfuric acid, the modified sulfuric acid of the present invention and a commercially available acid cleaner, designated herein as Deoxidizer Control, which was used as a control. As used herein, the terms “cleaner” and “deoxidizer” can be read interchangeably. The purpose was to identify a phosphate-free acid cleaner effective to remove both laser and weld scale.

A commercially available alkaline cleaner at a concentration of 6% was used to clean the oil/smut from metal parts prior to evaluating the metal loss effect and scale removal ability of several acid cleaners/deoxidizers. Each part contained both laser and weld scale that was visually evaluated for removal. The cleaning and metal loss process cycles used are set forth in Table 1.

TABLE 1

| | | | | |
|---|---|---|---|---|
| Stage | Material | Conc. | Time | Temp |

Cleaning Cycle

| | | | | | |
|---|---|---|---|---|---|
| 1 | Alkaline Cleaner | 6% | 4.5 | Min. | 150 F. |
| 2 | WWR | | 1.5 | Min. | |
| 3 | Pickle | | 3 | Min. | 150 F. |
| 4 | CWR | | 1.5 | Min. | |
| 5 | Alkaline Cleaner | 6% | 1.5 | Min. | 150 F. |
| 6 | CWR | | 0.5 | Min. | |
| 7 | Blow Dry | | | | |

Metal Loss Process Cycle

| | | | | | |
|---|---|---|---|---|---|
| 1 | Alkaline Cleaner | 2.5 oz./gal. | 5 | Min. | 150 F. |
| 2 | CWR | | 60 | sec. | |
| 3 | Blow Dry | | | | |
| 4 | Oven | | 5 | Min. | 275 F. |
| 5 | Weigh | | | | |
| 6 | Pickle | | 3 | Min. | 150 F. |
| 7 | CWR | | 60 | sec. | |
| 8 | Blow Dry | | | | |
| 9 | Oven | | 5 | min. | 150 F. |
| 10 | Weight | | | | |

Note:
“WWR” stands for warm water rinse and
“CWR” stands for cold water rinse.

The initial concentration of the acid cleaners used was 35%, which is the concentration of Deoxidizer Control used at present in actual commercial practice. Attempts to decrease the concentration of the acid pickles that worked were made and these concentrations were used in the metal etching studies.

Table 2 summarizes the initial results.

TABLE 2

| | | | | Scale | | |
|---|---|---|---|---|---|---|
| | | | Temp. | Removal | (Visual) | Metal Loss |
| Material | Conc. | Total Acid¹ | (° F.) | Laser Scale | Weld Scale | (mg/ft²) |
| Deoxidizer | 35% | 122 | 150 | Good | Good | NA |
| (Control) | | | | | | |
| Acid Deoxidizer #1 | 35% | | 150 | Good | Good | NA |
| Acid Deoxidize #1 | 25% | | 150 | Poor | Poor | NA |
| Acid Deoxidize #1 | 18% | | 150 | Poor | Poor | NA |
| Acid Deoxidizer #1 | 12.5% | | 150 | Poor | Poor | NA |
| Acid Deoxidizer #1 + | 15% | | 150 | Fair | Fair | NA |
| 1.5% Additive | | | | | | |
| A² | | | | | | |
| Acid Deoxidizer #2 | 35% | | 150 | Poor | Poor | NA |
| Modified Sulfuric | 35% | | 150 | Good | Good | NA |
| Acid | | | | | | |
| Modified Sulfuric | 25% | 67.5 | 150 | Good | Good | |
| Acid | | | | | | |
| Modified Sulfuric | 12.5% | | 150 | Good | Good | 2,800 |
| Acid | | | | | | |
| Modified Sulfuric | 6.25% | 15 | 150 | Good | Good | |
| Acid | | | | | | |
| Modified Sulfuric | 3% | | 150 | Poor | Poor | |
| Acid | | | | | | |
| Ammoniated Acid | 25% | 56 | 150 | Good | Good | |
| Ammoniated Acid | 12.5% | 27 | 150 | Good | Good | 2,300 |
| Ammoniated Acid | 6.25% | 12 | 150 | Fair | Good | |
| Ammoniated Acid + | 12.5% | 27 | 150 | Fair | Good | 2,900 |
| 0.5% Inhibitor | | | | | | |

¹Total acid (2 ml sample vs TS 11).
²Additive A is ammonium bifluoride and its addition is recommended on the Acid Deoxidizer #1 Technical Process Bulletin.

All the acid cleaners, except Acid Deoxidizer #2, removed both laser and weld scale at 35% concentration. The modified sulfuric acid of the present invention and ammoniated acid worked well at 35% and also at lower acid concentrations. Acid Cleaner #1 is an organic acid and sulfinuric acid mixture and Acid Deoxidizer #2 is an organic acid based formulation. A higher concentration of ammoniated acid (12.5%) was needed to get complete scale removal, as compared to 6.25% of the modified sulfuric acid of the present invention. However, the etch rate with the inventive product at 6.25% was equivalent (or slightly higher) to the etch rate for ammoniated acid at 12.5%. Adding an inhibitor to the ammoniated acid did not lower the etch rate. As the parts were processed, soluble iron increased in the acid cleaners. Much of the magnetized steel flakes on the bottom of the baths appeared to come from laser scale, which was removed from the part in “flakes” by the action of the acid on the metal surface. This material on the bottom of the container clings to a magnet.

A significant deterrent to using sulfuric acid-based pickles is the attack on stainless steel and the need for more expensive alloys for equipment in contact with the acid or use of rubber-lined tanks. The heated acid solutions blackened a stainless steel probe and the solutions turned green (leaching of chrome and nickel).

An etching study of the three acid cleaners with and without Rodine inhibitors was conducted with 304 stainless steel test panels at 150° F. for 48 hours. For uninhibited pickles, the metal loss in the room temperature pickles was rechecked 10 days later. Two inhibitors, Rodines 85 and 31A, were used. The results are summarized in Table 3.

TABLE 3

| | | | | | | Metal Loss |
|---|---|---|---|---|---|---|
| | | | | Metal Loss | Metal Loss | (mg/ft²) |
| | | Temp. | | (mg/ft²) | (mg/ft²) | 48 hrs + 10 |
| Acid Pickle | Conc. | (° F.) | Inhibitor/Conc. | 24 hrs | 48 hrs | days RT |
| Deoxidizer Control | 35% | 150 | None | NA | 0 | NA |
| Acid Deoxidizer #1 + | 35% | 150 | None | 21 | 23 | 22 |
| 1.5% Additive A | | | | | | |
| Acid Deoxidizer #1 + | 35% | 150 | Rodine 85/0.25% | NA | 4,100 | NA |
| 1.5% Additive A | | | | | | |
| Acid Deoxidizer #1 + | 35% | 150 | Rodine 31A | NA | 1,500 | NA |
| 1.5% Additive A | | | | | | |
| Ammoniated Acid | 12.5% | 150 | None | 11 | 12 | 13 |
| Ammoniated Acid | 12.5% | 150 | Rodine 85/0.25% | NA | 1,400 | NA |
| Ammoniated Acid | 12.5% | 150 | Rodine 31A | NA | 11 | NA |
| Modified Sulfaric | 6% | 150 | | 7 | 8 | 8 |
| Modified Sulfuric | 6% | 150 | Rodine 85/0.25% | NA | 0 | NA |
| Modified Sulfuric | 6% | 150 | Rodine 31A | NA | 1 | NA |
| HCl | 10% | 150 | None | 1,400 | NA | NA |

For uninhibited acid pickles at the concentrations needed for laser scale removal, 35% Acid Deoxidizer #1 had the highest etch rate (23 mg/ft²), followed by 12.5% ammoniated acid (12 mg/ft²), and 6% modified sulfuric (8 mg/ft²). The Deoxidizer Control at 35% displayed no metal loss at 48 hours at 150° F. Also, 10% HCl was tested and displayed a 1,400 mg/ft² metal loss at room temperature for 24 hours. Using Rodine 85 inhibitor (which also contains some HCl) increased the SS metal etch rates by 10³ for Acid Deoxidizer #1 and ammoniated acid cleaners. However, addition of 0.25% Rodine 85 decreased the etch rate on stainless steel to 0 mg/ft² for the modified sulfuric acid pickle of the present invention (150° F. for 48 hours). Also, addition of 0.25% Rodine 31A decreased the etch rate to 1 mg/ft² and optimization of Rodine concentration could further decrease the rate. Rodine 31A increased the etch rate of Acid Deoxidizer #1 and had little effect on ammoniated acid.

The effect of Rodine addition on scale removal of the various acid pickles was also investigated and the results are given in Table 4. Also, the effect of Rodine 85 on CRS panels was determined and found to decrease the etch rate, but not to a sufficient degree. Addition of Rodine 85 to all three acid pickles did not affect their ability to remove scale but it did cause heavy smutting on the surface of the round coupon. Much of the smut was attracted to a magnet and when dissolved in acid, gave a positive response for iron. Data are depicted in Table 4.

TABLE 4

| | | | | Metal Loss | | | | | |
|---|---|---|---|---|---|---|---|---|---|
| | | | | on ACT CRS | | | | | |
| | | | | Panels (mg/ft²) | | Flat Part | | Round Coupon | |
| Acid | | Tot | Temp | No | 0.25% | 0.25% | 0.1% | 0.25% | 0.1% |
| Pickle | (Wt %) | Acid | (° F.) | Inhib | Rodine 85 | Rodine 85 | Rodine 85 | Rodine 85 | Rodine 85 |
| Acid Deoxidizer | 35% | 48 | 150 | 100 | 20 | Laser + | | Laser scale | |
| #1 + 1.5% Add A | | | | | | weld scale | | removed - | |
| | | | | | | removed | | Heavy smut | |
| Ammoniated acid | 12% | 12 | 150 | 180 | 40 | Laser + | Laser scale | Laser scale | Laser scale |
| | | | | | | weld scale | removed | removed - | removed - |
| | | | | | | removed | | Heavy smut | Medium |
| | | | | | | | | | smut |
| Modified Sulfuric | 6% | 15 | 150 | 200 | 40 | Laser + | | Laser scale | |
| | | | | | | weld scale | | removed - | |
| | | | | | | removed | | Heavy smut | |

The room temperature 10% HCl pickle removed the weld scale and ˜80-90% of the laser scale on the part and also removed the laser scale from the flat round part, leaving a small amount of smut.

Ammoniated acid, the modified sulfuric acid of the present invention, and Acid Deoxidizer #1 are equivalent to the phosphoric acid-based Deoxidizer Control cleaner for scale removal on panels having weld and laser scale. All three of these acid cleaners contain some form of sulfuric acid and etch 304 stainless steel. Working bath concentrations for the different pickles are different and affect operating cost. The etch rate of Acid Deoxidizer #1 cleaner with either Rodine inhibitor is very large. Likewise, there was significant etch with ammoniated acid on stainless steel even after inhibitors were added. In contrast, both Rodine inhibitors decreased the etch rate for the modified sulfuric acid of the present invention and clearly differentiated it from the other products. However, all three cleaners tested with Rodine 85 addition caused heavy smutting of the round circle part, but other known techniques exist for mitigating this condition.

The results of these tests can be summarized as follows:

The best overall product which removed laser and weld scale and had ˜0 mg/ft² etch at 150° F. for 48 hours was the modified sulfuric acid of the present invention containing 0.25% Rodine 85.

Additional testing was carried out to determine the effectiveness of an inhibitor which is commercially available from E.I. DuPont de Nemours and Company under the trade designation ZONYL FSH. The ZONYL FSH product is a nonionic fluorosurfactant having a variety of uses. The ZONYL FSH product was added to the inventive modified sulfuric acid and tested on SS-316 stainless steel for 72 hours (with no other inhibitor added) at concentrations of 0.1%, 0.5% and 0.025% and temperatures of 150° F., 140° F. and 130° F. Other tests were conducted using the ZONYL FSH product with another inhibitor which is commercially available from Harry Miller Corporation under the trade designation ACTIVOL 1793® (“A-1793”), all of the tests being summarized in the following Table 4A:

TABLE 4A

| | Modified | | | | Corrosion | Tank 50% |
|---|---|---|---|---|---|---|
| Inhibitors | Sulfuric Acid | Temperature | Corrosion | Corrosion | 0.25 in Tank- | Corrosion |
| Tested | Conc. | Fahrenheit | mg/ft² | gm/ft²/yr | 100% years | Years |
| Zonyl FSH- | 15% | 150° F. | 67.5 | 8.2 | 578 | 289 |
| 0.1% | | | | | | |
| FSH- | 15% | 150° F. | 44.9 | 5.5 | 862 | 431 |
| 0.05% | | | | | | |
| FSH- | 15% | 150° F. | 54.0 | 6.6 | 718 | 359 |
| 0.025% | | | | | | |
| Zonyl | 15% | 150° F. | 67.5 | 8.2 | 578 | 289 |
| FSH-0.1% | | | | | | |
| A-1793 | | | | | | |
| 0.1% | | | | | | |
| Zonyl FSH | 15% | 150° F. | 67.5 | 8.2 | 578 | 289 |
| 0.1% | | | | | | |
| A-1793- | | | | | | |
| 0.05% | | | | | | |
| FSH-0.1% | 15% | 150° F. | 67.5 | 8.2 | 578 | 289 |
| A-1793- | | | | | | |
| 0.025% | | | | | | |
| FSH-0.1% | 15% | 140° F. | 67.5 | 8.2 | 578 | 289 |
| FSH-.05% | 15% | 140° F. | 67.5 | 8.2 | 578 | 289 |
| FSH-.025% | 15% | 140° F. | 67.5 | 8.2 | 578 | 289 |
| FSH-0.1% A- | 15% | 140° F. | 1123 | 137 | 34.6 | 17.3 |
| 1793-0.1% | | | | | | |
| FSH 0.1% A- | 15% | 140° F. | 1033 | 126 | 37.6 | 17.3 |
| 1793- | | | | | | |
| 0.05% | | | | | | |
| FSH-0.1% | 15% | 140° F. | 1841 | 224 | 21.2 | 10.6 |
| A-1793- | | | | | | |
| 0.025% | | | | | | |
| FSH-0.1% | 15% | 130° F. | 67.5 | 8.2 | 578 | 289 |
| FSH-.05% | 15% | 130° F. | 67.5 | 8.2 | 578 | 289 |
| FSH-.025% | 15% | 130° F. | 67.5 | 8.2 | 578 | 289 |
| FSH-0.1% A- | 15% | 130° F. | 1572 | 191 | 24.8 | 12.4 |
| 1793-0.1% | | | | | | |
| FSH 0.1% A- | 15% | 130° F. | 1751 | 213 | 22.3 | 11.2 |
| 1793- | | | | | | |
| 0.05% | | | | | | |
| FSH-0.1% | 15% | 130° F. | 2021 | 246 | 19.3 | 9.7 |
| A-1793- | | | | | | |
| 0.025% | | | | | | |
| FSH-0.1% A- | 15% | 120° F. | 44.9 | 5.5 | 862 | 431 |
| 1793-0.1% | | | | | | |
| FSH 0.1% A- | 15% | 120° F. | 44.9 | 5.5 | 862 | 431 |
| 1793- | | | | | | |
| 0.05% | | | | | | |
| FSH-0.1% | 15% | 120° F. | 44.9 | 5.5 | 862 | 431 |
| A-1793- | | | | | | |
| 0.025% | | | | | | |
| FSH-0.1% A- | 15% | 110° F. | 22.5 | 2.74 | 1730 | 865 |
| 1793-0.1% | | | | | | |
| FSH 0.1% A- | 15% | 110° F. | 22.5 | 2.74 | 1730 | 865 |
| 1793- | | | | | | |
| 0.05% | | | | | | |
| FSH-0.1% | 15% | 110° F. | 22.5 | 2.74 | 1730 | 865 |
| A-1793- | | | | | | |
| 0.025% | | | | | | |
| FSH-0.1% A- | 15% | R.T. | 22.5 | 2.74 | 1730 | 865 |
| 1793-0.1% | | (room | | | | |
| | | temperature) | | | | |
| FSH 0.1% A- | 15% | R.T. | 22.5 | 2.74 | 1730 | 865 |
| 1793- | | (room | | | | |
| 0.05% | | temperature) | | | | |
| FSH-0.1% | 15% | R.T. | 22.5 | 2.74 | 1730 | 865 |
| A-1793- | | (room | | | | |
| 0.025% | | temperature) | | | | |

*The final two columns are extrapolations of the test results indicating the number of years required for complete (100%) and 50% corrosion of a 0.25 inch thick SS-316 plate, respectively.

As the test results summarized in Table 4A demonstrate, the ZONYL FSH fluorosurfactant inhibitor in the 15% modified sulfuric acid provides outstanding corrosion resistance as to SS-316 stainless steel (the most common material used for process tanks in industrial applications). While the addition of the ACTIVOL 1793 inhibitor to the ZONYL FSH inhibitor is detrimental as to use on SS-316 (and likely other stainless steels), it may be necessary when used on CRS as being more able to increase the corrosion resistance than the ZONYL FSH product.

Further tests were conducted to compare the modified sulfuric acid of the present invention to 66° Baume sulfuric acid. The modified sulfuric acid was tested at 16% by weight of the 66° Baume sulfuric acid at 10% on 304 and 316 grades of stainless steel and also on hot rolled steel (HRS). In all cases, these tests were conducted without the inclusion of metal attack inhibitors or other compounds. The objective was to compare metal loss (etch) of the products. The results of those tests are in Table 5.

TABLE 5

| | | |
|---|---|---|
| Stage 1: | Acetone | Concentration: |
| | cleaned | 66° Be′ H₂SO₄ 10% |
| Stage 2: | Weight part or panel | Modified H₂SO₄ 16% |
| Stage 3: | Acid Pickle, 5 minutes unless | Metal Loss = 144 * (Initial weight-Final eight)/sample |
| | noted | surface area (in square inches). |
| Stage 4: | Water Rinsed, 30 seconds | |
| Stage 5: | Acetone rinse | |
| Stage 6: | Air Dry | |
| Stage 7: | Re-weigh Panel | |

| | | | | | | | | Total | | |
|---|---|---|---|---|---|---|---|---|---|---|
| | | | | | | Wt | Wt | Metal | | |
| Surface | | Bath | Temp | Part | Surface | Before | After | Loss | Etch | Observations/ |
| ID | Chemistry | Conc. | (° F.) | Size | (in²) | (gms) | (gms) | (gms) | (gms/ft²) | Comments |
| 304 SS | 66° Be′ H₂SO₄ | 10.0% | 150 | 3.0 × 4.0 | 24.00 | 85.6331 | 85.5099 | 0.1232 | 0.739 | A lot of gassing |
| | | | 150 | 2.8125 × 4.0 | 22.50 | 87.7903 | 87.6631 | 0.1272 | 0.814 | and surface has |
| | | | | | | | | | | appearance. |
| | | | | | | | | | | Solution green |
| | | | | | | | | | | in color |
| 304 SS | Modified | 16.0% | 150 | 3.0 × 4.0 | 24.00 | 85.3746 | 85.3717 | 0.0029 | 0.017 | Shiny surface |
| | H₂SO₄ | | 150 | 3.0 × 4.0 | 24.00 | 87.1861 | 87.1819 | 0.0042 | 0.025 | appearance very |
| | | | | | | | | | | little attack |
| HRS | 66° Be′ H₂SO₄ | 10.0% | 150 | 3.0 × 4.0 | 24.00 | 113.7966 | 113.402 | 0.3948 | 2.369 | |
| | | | 150 | 3.0 × 4.0 | 24.00 | 115.942 | 115.538 | 0.404 | 2.424 | |
| HRS | Modified | 16.0% | 150 | 3.0 × 4.0 | 24.00 | 114.6281 | 114.519 | 0.1096 | 0.658 | |
| | H₂SO₄ | | 150 | 3.0 × 4.0 | 24.00 | 115.9538 | 115.831 | 0.1228 | 0.737 | |
| 316 SS | 66° Be′ H₂SO₄ | 10.0% | 150 | 2.94 × 4.0 | 23.50 | 52.6338 | 52.4872 | 0.1766 | 1.082 | 10 minute |
| | | | 150 | 2.8125 × 4.0 | 24.00 | 53.034 | 52.8526 | 0.1814 | 1.088 | Pickle, surface |
| | | | | | | | | | | darker, |
| | | | | | | | | | | solution |
| | | | | | | | | | | green in color |
| 316 SS | Modified | 16.0% | 150 | 3.0 × 4.0 | 24.00 | 52.212 | 52.2102 | 0.0018 | 0.011 | |
| | H₂SO₄ | | 150 | 3.0 × 4.0 | 24.00 | 53.1212 | 53.1196 | 0.0016 | 0.010 | |

Examination of the test results indicates that the modified sulfuric acid of the invention shows a significantly lower metal loss on all three substrates. In the case of the 304 stainless steel surfaces this amounts to a forty-fold reduction and in the case of the 316 stainless steel surface to a one hundred fold reduction in metal loss. Even in the case of CRS, the most reactive surface, a three fold reduction in metal loss is indicated.

Additional tests were conducted to determine the advantages of the modified sulfuric acid of the present invention in the areas of remedial metal treatment and mineral deposit removal. The tests were conducted comparing the inventive modified sulfuric acid as an oxidation and/or mineral deposit removal agent for brass, chrome, copper, and ceramic tile compared to other commercially available products. The results of these tests are approximate and are as follows based on visual observation:

TABLE 6A
Removal of Mineral Deposits (3 Minute Test)
Comparison of Inventive Product to Commercially Available Mineral Deposit Removers

| | | | | | Visual Observation |
|---|---|---|---|---|---|
| Material | Product | Concentration | pH | Application Duration | (approximate values) |
| Ceramic Tile with | Kaboom | Direct spray per | 2.2 | Applied - soak for | Wiped with wet sponge |
| heavy mineral deposits | | label directions | | 3 minutes | 60% deposit removed |
| Ceramic Tile with | Magichem | 1:1 dilution per | 0.7 | Applied - soak for | Wiped with wet sponge |
| heavy mineral deposits | | label directions | | 3 minutes | 55% deposit removed |
| Ceramic Tile with | Scrubbing | Full strength per | 5.0 | Applied - soak for | Wiped with wet sponge |
| heavy mineral deposits | Bubbles | label directions | | 3 minutes | 25% deposit removed |
| Ceramic Tile with | CLR | Full strength per | 1.6 | Applied - soak for | Wiped with wet sponge |
| heavy mineral deposits | | label directions | | 3 minutes | 45% deposit removed |
| Ceramic Tile with | Modified | 1% Acid | 1.1 | Applied - soak for | Wiped with wet sponge |
| heavy mineral deposits | Sulfuric Acid | | | 3 minutes | 95% deposit removed |

TABLE 6B
Removal of Mineral Deposits (24 Hour Test)
Comparison of Inventive Product to Commercially Available Mineral Deposit Removers

| | | | | | Visual Observation¹ |
|---|---|---|---|---|---|
| Material | Product | Concentration | pH | Application Duration | (approximate values) |
| Chrome plated | Kaboom | Direct spray per | 2.2 | Applied - soak for | Wiped with wet sponge |
| copper pipe* | | label directions | | 24 hours | 80% deposit removed |
| Chrome plated | Magichem | 1:1 dilution per | 0.7 | Applied - soak for | Wiped with wet sponge |
| copper pipe* | | label directions | | 24 hours | 70% deposit removed |
| Chrome plated | Scrubbing | Full strength per | 5.0 | Applied - soak for | Wiped with wet sponge |
| copper pipe* | Bubbles | label directions | | 24 hours | 45% deposit removed |
| Chrome plated | CLR | Full strength per | 1.6 | Applied - soak for | Wiped with wet sponge |
| copper pipe* | | label directions | | 24 hours | 60% deposit removed |
| Chrome plated | Modified | 2% Acid & | 0.9 | Applied - soak for | Wiped with wet sponge |
| copper pipe* | Sulfuric Acid | 2% non-ionic | | 24 hours | 100% deposit removed |
| | | surfactant | | | |

*Heavy Mineral Deposits
¹Observation of removal of mineral deposits.

TABLE 7
Comparison of Inventive Product to a Commercially Available Metal Polish

| | | | | | Visual Observation |
|---|---|---|---|---|---|
| Material | Product | Concentration | pH | Application Duration | (approximate values) |
| Copper Pipe** | Brasso | Full strength per | | Applied - soak for | Agressively rubbed 1 |
| | | label directions | | 1 minute | minute to remove 65% |
| | | | | | of patina |
| Brass Rod** | Brasso | Full strength per | | Applied - soak for | Agressively rubbed 1 |
| | | label directions | | 1 minute | minute to remove 45% |
| | | | | | of patina |
| Copper Pipe** | Modified | 2% Acid & | | Applied - soak for | Gently rubbed 15 |
| | Sulfuric Acid | 2% non-ionic | | 15 Seconds | seconds to remove |
| | | surfactant | | | 85% of patina |
| Brass Rod** | Modified | 2% Acid & | | Applied - soak for | Gently rubbed 15 |
| | Sulfuric Acid | 2% non-ionic | | 15 Seconds | seconds to remove |
| | | surfactant | | | 90% of patina |

**Heavy Patina

Product safety is an important characteristic of any commercial product. This invention imparts an element of safety to users and their processing equipment in two ways. First, reduction of metal loss extends the life of process equipment (see Tables 2 through 5). Second, commercial sulfuric acid may destroy the epidermis and penetrate some distance into the skin and subcutaneous tissue and cause ulceration of the skin. On the other hand, the modified sulfuric acid of the present invention has been shown to be comparatively safe in relevant tests of dermal irritation using New Zealand white rabbits. Primary Dermal Irritation/Corrosion Studies of the inventive product were conducted by Corning Hazelton, Inc. utilizing the Draize technique. The concentration of the product was 10% and the pH was 0.40. The primary dermal irritation potential was evaluated on three rabbits under a 4-hour semioccluded condition. The test material produced very slight to well-defined erythema and very slight to slight edema reactions. No other dermal irritation was observed. All irritation cleared by the end of a 96 hour observation period. The average of the individual index scores (the total of erythema and edema scores at 4, 24, 48, and 72 hours divided by 4) was 1.8 (considered to be slightly irritating under the Draize Technique). All procedures used in this study were in compliance with the Animal Welfare Act Regulations. The dose, method, frequency, and duration of administration utilized in the study were chosen based on the requirements of the appropriate regulatory test guidelines.

These tests indicate that in concentrations of 10%, the inventive product demonstrates low dermal toxicity to this hypersensitive creature. While at full strength, the inventive sulfuric acid product demonstrated significant irritation to the rabbits, it can logically be assumed that because human skin is less sensitive than the skin of white rabbits, stronger concentrations than the 10% level can be safely tolerated by humans. Data in Tables 2-5 indicate that the inventive product performs well in the metal working industry for the intended purposes at a concentration of approximately 6.5%, thus demonstrating that the inventive modified sulfuric acid is reasonably safe compared to commodity sulfuric acid which causes significant dermal damage at these concentrations.

Because of this safety factor, it is possible to ship products for the uses claimed, which have been formulated using ammoniated compounds and which have inherent safety characteristics, at freight rates advantageous over other sulfuric acid formulations and other organic and inorganic products. Under OSHA (the Occupational Safety and Health Administration) and DOT (Department of Transportation) data and classifications, many acids must be shipped under “hazardous” shipping classes which carry considerably higher shipping rates than non-hazardous products. Because the inventive sulfuric acid product exhibits inherent safety at least up to certain threshold concentrations, concentrations at or below this threshold could logically qualify for shipment at non-hazardous rates.

Further, the safety imparted by the modified sulfuric acid of the present invention makes it possible to include it within consumer products intended to be used as tub and tile cleaners, toilet bowl cleaners, or metal cleaners or polishes where commercial sulfuric acid would not be safe to use.

The deposition of “scale” on the operating surfaces of boilers or cooling water systems (towers) and within the plumbing which comprises these systems greatly decreases their efficiency. Accordingly, energy costs for the users of such systems increase as system efficiency decreases. Due to the characteristics of the modified sulfuric acid of the present invention, it is suitable for use both to remove deposited water scales or, with its inclusion within the water within the boiler or water cooling system, to reduce, mitigate, or control water scale deposits within these systems.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

1. A process for treating metal comprising contacting a surface of the metal with a formulation which includes sulfuric acid, water, and a substance selected from the group consisting of anhydrous ammonia, ammonia and a sulfate salt of ammonia.

2. A process as set forth in claim 1, wherein said formulation includes by weight:
sulfuric acid in the range of approximately 46-67%,
water in the range of approximately 25-46%, and
anhydrous ammonia in the range of approximately 1-8.0%.

3. A process as set forth in claim 1, wherein said formulation includes by weight:
sulfuric acid in the range of approximately 51-62%,
water in the range of approximately 35-46%, and
anhydrous ammonia in the range of approximately 2.2-3.0%.

4. A process as set forth in claim 1, wherein said formulation includes by weight:
sulfuric acid in the range of approximately 54-56%,
water in the range of approximately 41-43%, and
anhydrous ammonia in the range of approximately 2.4-2.9%.

5. A process as set forth in claim 1, wherein said formulation is prepared by blending said sulfuric acid and water to obtain a mixture thereof and then adding said anhydrous ammonia to the mixture.

6. A process as set forth in claim 1, wherein said formulation includes an inhibitor for inhibiting etching of the metal.

7. A process as set forth in claim 6, wherein said inhibitor comprises a nonionic fluorsurfactant.

8. A process as set forth in claim 1, wherein said formulation includes an etching accelerator.

9. A process as set forth in claim 1, wherein said formulation includes a buffer.

10. A process as set forth in claim 1, wherein said formulation includes a surfactant.

11. A process as set forth in claim 1, wherein said formulation is present in a concentration of between about 0.5% and about 60% by weight.

12. A process as set forth in claim 1, wherein said formulation is present in a concentration of between about 3% and about 25% by weight.

13. A process as set forth in claim 1, wherein said formulation is present in a concentration of about 6.25% by weight.

14. A process for removing surface impurities from metal comprising applying to the metal a formulation that includes sulfuric acid, water, and a substance selected from the group consisting of anhydrous ammonia, ammonia and a sulfate salt of ammonia.

15. A process for removing minerals from a water handling system having metal components comprising applying to the system a formulation that includes sulfuric acid, water, and a substance selected from the group consisting of anhydrous ammonia, ammonia and a sulfate salt of ammonia.

16. A formulation applicable to metal for removing surface impurities from the metal, said formulation comprising sulfuric acid, water, and a substance selected from the group consisting of anhydrous ammonia, ammonia and a sulfate salt of ammonia.

17. A formulation as set forth in claim 16, wherein said formulation is present in a concentration of between about 3% and about 25% by weight.

18. A formulation as set forth in claim 16, wherein said formulation is present in a concentration of about 6.25% by weight.

19. A formulation as set forth in claim 16, including an inhibitor for inhibiting etching of the metal.

20. A formulation as set forth in claim 19, wherein said inhibitor comprises a nonionic fluorosurfactant.

21. A formulation applicable to metal for removing surface impurities from the metal, said formulation comprising:
a metal cleaning agent; and
a mixture of sulfuric acid, water, and a substance selected from the group consisting of anhydrous ammonia, ammonia and a sulfate salt of ammonia.

22. A formulation as set forth in claim 21, wherein said formulation is present in a concentration of between about 3% and about 25% by weight.

23. A formulation as set forth in claim 21, wherein said formulation is present in a concentration of about 6.25% by weight.

24. A metal product resulting from a process that includes providing a metal piece having oxidation or contaminants and treating the metal piece to reduce said oxidation or contaminants by contacting the metal piece with a formulation that includes sulfuric acid, water, and a substance selected from the group consisting of anhydrous ammonia, ammonia and a sulfate salt of ammonia.

25. A metal product as set forth in claim 24, where formulation is present in said formulation in a concentration of approximately 6.25% by weight.
